(19) United States
(12) Patent Application Publication
(10) Pub. No.: US 2009/0137273 A1
(43) Pub. Date: May 28, 2009

(54) DUAL CHANNEL BROADCAST RECEIVER AND MOBILE TERMINAL HAVING SAME

(76) Inventor: Motofumi Yamaguchi, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/243,162

(22) Filed: Oct. 1, 2008

(30) Foreign Application Priority Data
Nov. 27, 2007 (JP) 2007-305920

(51) Int. Cl. H04M 1/00; H04B 1/18

(52) U.S. Cl. 455/556.1; 455/150.1

(57) ABSTRACT

A dual channel broadcast receiver includes: a first receiving section having a first antenna, a first low noise amplifier for amplifying a signal received by the first antenna, and a first power divider for dividing a signal fed from the first low noise amplifier into two signals to be outputted therefrom; a second receiving section having a second antenna, a second low noise amplifier for amplifying a signal received by the second antenna, and a second power divider for dividing a signal fed from the second low noise amplifier into two signals to be outputted therefrom; a dual tuner having a first RF input terminal and a second RF input terminal; and a selecting section for, in dual channel reception, selecting and feeding to the first and second RF input terminals either a signal fed from the first receiving section or a signal fed from the second receiving section. The dual channel broadcast receiver does not supply power to an antenna that is not being used.

This nonprovisional application claims priority under 35 U.S.C. §19(a) on Patent Application No. 2007-305920 filed in Japan on Nov. 27, 2007, the entire contents of which are hereby incorporated by reference.

### BACKGROUND OF THE INVENTION

1. Field of the Invention

The present invention relates to a dual channel broadcast receiver and a mobile terminal such as a cellular phone unit.

2. Description of Related Art

An example of digital television receivers available for use in car navigation systems and the like is an OFDM (orthogonal frequency division multiplexing) receiver proposed in Japan Patent Application Laid-open No. 2004-274603. This OFDM receiver has a plurality of antennas and a plurality of tuners provided one for each of the plurality of antennas. In an antenna selecting mode for selecting an antenna, one of the antennas from which a reception signal having the strongest signal power can be obtained is selected, and antenna selecting diversity reception is performed by turning on a switch provided between this selected antenna and a tuner corresponding thereto and turning off switches provided between the other antennas and tuners corresponding thereto. In a sub-carrier selectively combining mode for performing selective combination for each sub-carrier, sub-carrier selectively combining diversity reception is performed by turning on all the switches provided one between each antenna and a tuner corresponding thereto and comparing and selectively combining the reception powers of the antennas for each sub-carrier at a sub-carrier selecting section that follows the tuners after an OFDM modulated reception signal is down-converted, A/D converted, and discrete-Fourier transformed by the tuners.

However, although the OFDM receiver proposed in Japan Patent Application Laid-open No. 2004-274603 is capable of performing single-channel reception, it is not capable of performing dual-channel reception.

For example, a dual channel broadcast receiver capable of performing dual channel reception is necessary in order to simultaneously receive broadcast signals of two channels (for example, in the case of performing dual screen display) with a terrestrial digital television receiver incorporated in a mobile terminal. With the circuit configuration of a conventional dual channel broadcast receiver, in a mobile terminal having two antennas which are each independently supplied with power, outputs from the antennas are each independently connected to a corresponding input terminal of a dual tuner. In this case, in a frequency band of about 100 to 800 MHz, for example, of terrestrial digital broadcast, since the two antennas are located very close to each other with respect to the wavelength of reception signals they receive, they have high correlation with each other, and this results in mutual coupling between the two antennas. Thus, with the circuit configuration of the conventional dual channel broadcast receiver, absolute gains G2 and G3 of two antennas of a dual channel broadcast receiver is disadvantageously lower than an absolute gain G1 of an antenna of a single channel broadcast receiver having the antenna and a tuner corresponding thereto (see FIG. 4).

### SUMMARY OF THE INVENTION

An object of the present invention is to provide a dual channel broadcast receiver capable of performing dual channel reception without reducing an antenna gain, and a mobile terminal incorporating the same.

To achieve the above object, according to one aspect of the present invention, a dual channel broadcast receiver includes: a first receiving section having: a first antenna; a first low noise amplifier for amplifying a signal received by the first antenna; and a first power divider for dividing a signal fed from the first low noise amplifier into two signals to be outputted therefrom; a second receiving section having: a second antenna; a second low noise amplifier for amplifying a signal received by the second antenna; and a second power divider for dividing a signal fed from the second low noise amplifier into two signals to be outputted therefrom; a dual tuner having a first RF (radio frequency) input terminal and a second RF input terminal; and a selecting section for, in dual channel reception, selecting and feeding to the first RF input terminal and the second RF input terminal either a signal fed from the first receiving section or a signal fed from the second receiving section. Here, in dual channel reception, when the selecting section selects the signal fed from the first receiving section, power is not supplied to the second antenna, and when the selecting section selects the signal fed from the second receiving section, power is not supplied to the first antenna.

With this configuration, since only either the first antenna or the second antenna is used in dual channel reception, no mutual coupling occurs between the first and second antennas. This enables dual channel reception to be performed with no reduction in antenna gain.

According to the present invention, it is preferable that the first and the second power dividers be Wilkinson type power dividers. This helps make the first and second power dividers low-loss, and thus makes it easier to secure a sufficiently high level of a signal that is fed to the dual tuner.

According to the present invention, in the dual channel broadcast receiver having either one of the above described configurations, there may be provided a power supply control circuit for individually turning on/off power supply to the first low noise amplifier and power supply to the second low noise amplifier. This helps realize a low power-consumption dual channel broadcast receiver.

According to the present invention, in the dual channel broadcast receiver having any one of the above described configurations, the dual tuner may be a tuner capable of switching between dual channel reception and single channel reception. This makes single channel reception possible as well.

According to the present invention, in the dual channel broadcast receiver having any one of the above described configurations, the selecting section may be configured such that it has a first semiconductor switch for selecting and feeding to the first RF input terminal either the signal fed from the first receiving section or the signal fed from the second receiving section, and a second semiconductor switch for selecting and feeding to the second RF input terminal either the signal fed from the first receiving section or the signal fed from the second receiving section.

According to the present invention, in the dual channel broadcast receiver having any one of the above described configurations, the selecting section may be configured such that it has a first RF MEMS (radio frequency micro electro mechanical systems) switch for selecting and feeding to the first RF input terminal either the signal fed from the first receiving section or the signal fed from the second receiving section, and a second RF MEMS switch for selecting and feeding to the second RF input terminal either the signal fed from the first receiving section or the signal fed from the second receiving section.

To achieve the above object, according to another aspect of the present invention, a mobile terminal includes the dual channel broadcast receiver having any one of the above described configurations.

According to the present invention, since only either one of the first and second antennas is used in dual channel reception, no mutual coupling occurs between the first and second antennas, and thus dual channel reception can be performed without causing any reduction in antenna gain.

### BRIEF DESCRIPTION OF THE DRAWINGS

FIG. 1 is a diagram showing an external view of a dual channel broadcast receiver of the present invention which is to be incorporated in a clamshell type mobile telephone unit.

FIG. 2 is a diagram showing an example of the configuration of a dual channel broadcast receiving circuit block.

FIG. 3 is a diagram showing an example of the configuration of a dual tuner capable of diversity reception.

FIG. 4 is a diagram showing gain characteristics of antennas of conventional receivers.

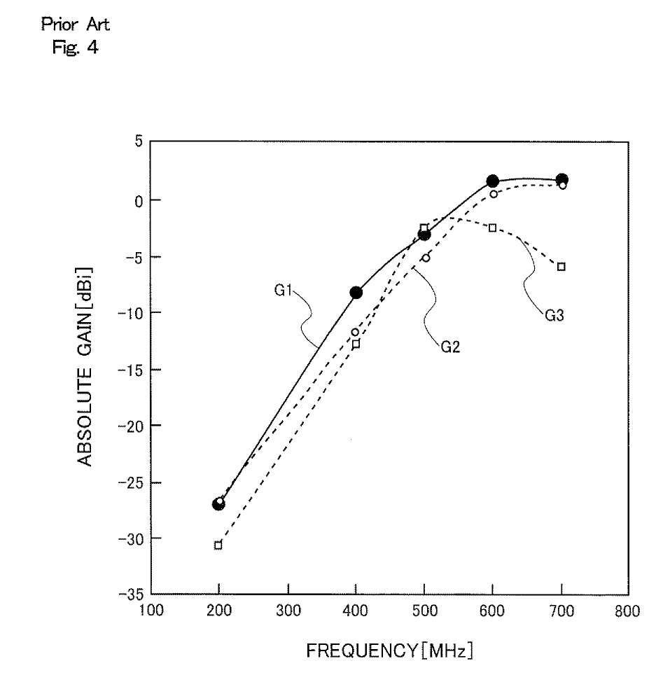

### DETAILED DESCRIPTION OF PREFERRED EMBODIMENTS

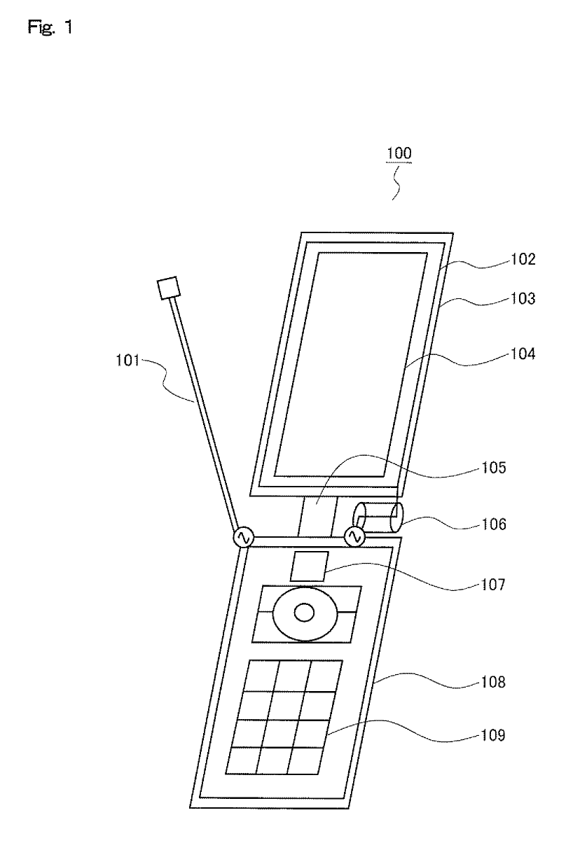

A description will be given below of embodiments of the present invention with reference to the accompanying drawings. FIG. 1 shows an external view of a dual channel broadcast receiver 100 of the present invention which is to be incorporated in a clamshell type mobile telephone unit.

The dual channel broadcast receiver 100 of the present invention is formed of a rod antenna 101, an in-case antenna 102, a video processing circuit block (not shown) and an audio processing circuit block (not shown) that are mounted on a display-side circuit board 103, a display 104 for displaying video based on an output from the video processing circuit block and a speaker (not shown) for outputting sound based on an output from the audio processing circuit block, a flat cable 105, an electrically conductive hinge 106, a dual channel broadcast receiving circuit block 107 mounted on a main body-side circuit board 108, and a keypad 109. The operation of the dual channel broadcast receiver 100 of the present invention is controlled by a microcomputer (not shown) that performs overall control of the clamshell type mobile telephone unit.

Through the flat cable 105, signals are sent between the dual channel broadcast receiving circuit block 107 mounted on the main body-side circuit board 108 and the video processing circuit block (not shown) and the audio processing circuit block (not shown) both mounted on the display-side circuit board 103, and power is supplied to the video processing circuit block (not shown), to the audio processing circuit block (not shown), both of which are mounted on the display-side circuit board 103, and to the display 104. The flat cable 105 electrically connects a predetermined conductor printed on the main body-side circuit board 108 to a predetermined conductor printed on the display-side circuit board 103.

The rod antenna 101 is formed of a rod-shaped metal radiating element and a ground pattern formed on the main body-side circuit board 108, and a connection point between the rod-shaped metal radiating element and the ground pattern formed on the main body-side circuit board 108 is a feeding point. The in-case antenna 102 provided on the display-side circuit board 103 and a feeding point of the in-case antenna 102 formed on the main body-side circuit board 108 is connected to each other through the electrically conductive hinge 106.

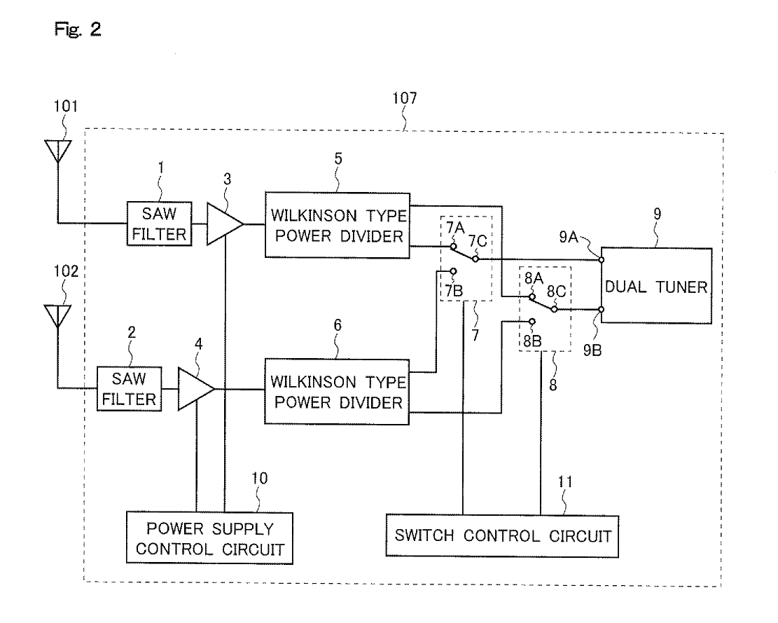

Next, a detailed description will be given of the dual channel broadcast receiving circuit block 107. FIG. 2 shows an example of the configuration of the dual channel broadcast receiving circuit block 107. In FIG. 2, parts that are the same as those in FIG. 1 are given the same reference numerals and a detailed description thereof will be omitted.

The dual channel broadcast receiving circuit block 107 shown in FIG. 2 includes SAW (surface acoustic wave) filters 1 and 2, low noise amplifiers 3 and 4, Wilkinson type power dividers 5 and 6, RF switches 7 and 8, a dual tuner 9, a power supply control circuit 10, and a switch control circuit 11.

An RF signal outputted from the rod antenna 101 is amplified by the low noise amplifier 3 after an interfering wave is removed therefrom by the SAW filter 1; then power division of the RF signal is performed by the Wilkinson type power divider 5 which is a one input two-output power divider, and one portion of the divided RF signal is sent to a connection point 7A of the RF switch 7 which is a two input one-output switch, whereas the other portion of the divided RF signal is sent to a connection point 8A of the RF switch 8 which is a two input one-output switch.

On the other hand, an RF signal outputted from the in-case antenna 102 is amplified by the low noise amplifier 4 after an interfering wave is removed therefrom by the SAW filter 2; then a power division of the RF signal is performed by the Wilkinson type power divider 6 which is a one input two-output power divider, and one portion of the divided RF signal is sent to a connection point 7B of the two input one-output RF switch 7, whereas the other portion of the divided RF signal is sent to a connection point 8B of the two input one-output RF switch 8.

A pole 7C of the RF switch 7 is connected to an RF input terminal 9A of the dual tuner 9, which means that an output of the RF switch 7 is connected to the RF input terminal 9A of the dual tuner 9, and a pole 8C of the RF switch 8 is connected to an RF input terminal 9B of the dual tuner 9, which means that an output of the RF switch 8 is connected to the RF input terminal 9B of the dual tuner 9. The dual tuner 9 can perform channel selection and demodulation independently with respect to each of RF signals it receives through the RF input terminals 9A and 9B.

The power supply control circuit 10 turns on/off power supply to the low noise amplifier 3 and power supply to the low noise amplifier 4 in an independent manner.

The switch control circuit 11 feeds a control signal to each of the RF switches 7 and 8. For example, when the RF switches 7 and 8 are CMOS (complementary metal oxide semiconductor) SPDT (single pole double throw) switches, it is preferable that a control signal fed to the RF switch 7 from the switch control circuit 11 and a control signal fed to the RF switch 8 from the switch control circuit 11 be each a signal having two voltage values such as 1.8 V and 0 V. Instead of CMOS switches, RF MEMS switches may be used as the RF switches 7 and 8.

In normal dual channel reception, power is supplied to the rod antenna 101, whereas no power is supplied to the in-case antenna 102. The power supply control circuit 10 applies 3 V to the low noise amplifier 3 to turn on the power supply to the low noise amplifier 3, whereas it applies 0 V to the low noise amplifier 4 to turn off the power supply to the low noise amplifier 4. The RF switch 7 selects the connection point 7A such that an RF signal outputted from the Wilkinson type power divider 5 is fed to the RF input terminal 9A of the dual tuner 9; the RF switch 8 selects the connection point 8A such that an RF signal outputted from the Wilkinson type power divider 5 is fed to the RF input terminal 9B of the dual tuner 9. For the purpose of not supplying power to the in-case antenna 102, it is necessary to disable the low noise amplifier 4. Incidentally, in the case where the low noise amplifier 4 has a pass-through function as well, it is necessary to disable not only the amplifying function but also the pass-through function of the low noise amplifier 4. In this embodiment, the low noise amplifier 4 is disabled by turning off the power supply thereto.

On the other hand, in the case where the rod-shaped metal radiating element of the rod antenna 101 is placed inside the clamshell type mobile telephone unit, or in the case where it can be assumed that the sensitivity of the rod antenna 101 is highly degraded, it is preferable that power be supplied to the in-case antenna 102 but not to the rod antenna 101, that the power supply control circuit 10 apply 0 V to the low noise amplifier 3 to turn off the power supply to the low noise amplifier 3 and apply 3 V to the low noise amplifier 4 to turn on the power supply to the low noise amplifier 4, that the RF switch 7 select the connection point 7B such that an RF signal outputted from the Wilkinson type power divider 6 is fed to the RF input terminal 9A of the dual tuner 9, and that the RF switch 8 select the connection point 8B such that an RF signal outputted from the Wilkinson type power divider 6 is fed to the RF input terminal 9B of the dual tuner 9. For the purpose of not supplying power to the rod antenna 101, it is necessary to disable the low noise amplifier 3. Incidentally, in the case where the low noise amplifier 3 has a pass-through function as well, it is necessary to disable not only the amplifying function but also the pass-through function of the low noise amplifier 3. In this embodiment, the low noise amplifier 3 is disabled by turning off the power supply thereto. Detection of whether or not the rod-shaped metal radiating element of the rod antenna 101 is placed inside the clamshell type mobile telephone unit can be achieved, for example, by providing a contact switch for detecting contact of the rod antenna 101 with a housing section thereof when the rod antenna 101 is placed in the housing section. Whether or not it can be assumed that the sensitivity of the rod antenna 101 is highly degraded can be judged, for example, by checking the level of an input signal fed to the RF input terminal 9A when the connection point 7A is selected by the RF switch 7.

In order to achieve a configuration capable of switching between dual channel reception and single channel reception, the dual tuner 9 in the dual channel broadcast receiving circuit block 107 shown in FIG. 2 may be replaced with a single channel-reception dual tuner 12 which is capable of both dual channel reception and single channel reception.

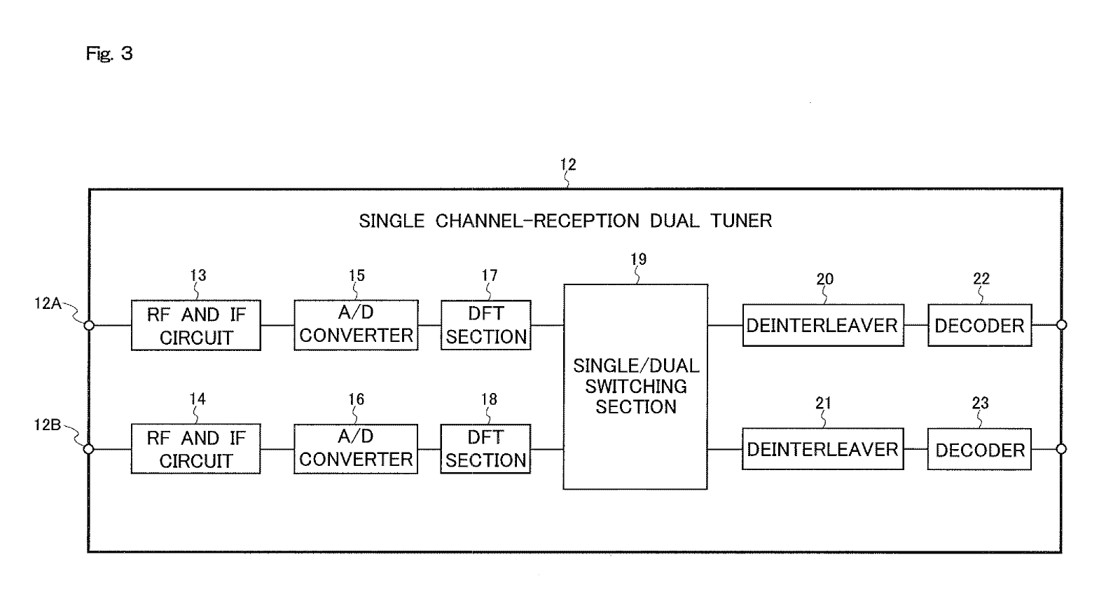

An example of the configuration of the single channel-reception dual tuner 12 is shown in FIG. 3. The single channel-reception dual tuner 12 shown in FIG. 3 includes an RF input terminal 12A, an RF input terminal 12B, RF and IF (radio frequency and intermediate frequency) circuits 13 and 14, A/D (analog/digital) converters 15 and 16, DFT (discrete Fourier transform) sections 17 and 18, single-channel-reception/dual-channel-reception switching section 19 (hereinafter, referred to as single/dual switching section 19), deinterleavers 20 and 21, and decoders 22 and 23.

The RF and IF circuit 13 down-converts an RF signal received through the RF input terminal 12A which is connected to the pole 7C of the RF switch 7 (i.e., the output of the RF switch 7), to an IF signal with a local oscillator signal that corresponds to a desired channel. The IF signal outputted from the RF and IF circuit 13, after being converted to a digital signal by the A/D converter 15, is OFDM demodulated by the DFT section 17 to be fed to the single/dual switching section 19.

Likewise, the RF and IF circuit 14 down-converts an RF signal received through the RF input terminal 12B, which is connected to the pole 8C of the RF switch 8 (i.e., the output of the RF switch 8), to an IF signal with a local oscillator signal that corresponds to a desired channel. The IF signal outputted from the RF and IF circuit 14, after being converted to a digital signal by the A/D converter 16, is OFDM demodulated by the DFT section 18 to be fed to the single/dual switching section 19.

Now, a description will be given of operation of dual channel reception. In dual channel reception, as in the case where the dual tuner 9 is used, it is preferable that power be supplied to the rod antenna 101 but not to the in-case antenna 102, that the power supply control circuit 10 apply 3 V to the low noise amplifier 3 to turn on the power supply to the low noise amplifier 3 and apply 0 V to the low noise amplifier 4 to turn off the power supply to the low noise amplifier 4, that the RF switch 7 select the connection point 7A such that an RF signal outputted from the Wilkinson type power divider 5 is fed to the RF input terminal 12A of the single channel-reception dual tuner 12, and that the RF switch 8 select the connection point 8A such that an RF signal outputted from the Wilkinson type power divider 5 is fed to the RF input terminal 12B of the single channel-reception dual tuner 12. Or, it is preferable that power be supplied to the in-case antenna 102 but not to the rod antenna 101, that the power supply control circuit 10 apply 0 V to the low noise amplifier 3 to turn off the power supply to the low noise amplifier 3 and it apply 3 V to the low noise amplifier 4 to turn on the power supply to the low noise amplifier 4, that the RF switch 7 select the connection point 7B such that an RF signal outputted from the Wilkinson type power divider 6 is fed to the RF input terminal 12A of the single channel-reception dual tuner 12, and that the RF switch 8 select the connection point 8B such that an RF signal outputted from the Wilkinson type power divider 6 is fed to the RF input terminal 12B of the single channel-reception dual tuner 12.

In these cases, the single/dual switching section 19 sends a demodulation signal received from the DFT section 17 to the deinterleaver 20, and sends a demodulation signal received from the DFT section 18 to the deinterleaver 21. The demodulation signal sent to the deinterleaver 20, after being subjected to various deinterleaving processes by the deinterleaver 20, is decoded by the decoder 22 to be outputted as a transport stream signal from the single channel-reception dual tuner 12. The demodulation signal sent to the deinterleaver 21, after being subjected to various deinterleaving processes by the deinterleaver 21, is decoded by the decoder 23 to be outputted as a transport stream signal from the single channel-reception dual tuner 12.

Next, a description will be given of operation of single channel reception. In single channel reception, as in dual channel reception, it is preferable that power be supplied to the rod antenna 101 but not to the in-case antenna 102, that the power supply control circuit 10 apply 3 V to the low noise amplifier 3 to turn on the power supply to the low noise amplifier 3 and it apply 0 V to the low noise amplifier 4 to turn off the power supply to the low noise amplifier 4, that the RF switch 7 select the connection point 7A such that an RF signal outputted from the Wilkinson type power divider 5 is fed to the RF input terminal 12A of the single channel-reception dual tuner 12, and that the RF switch 8 select the connection point 8A such that an RF signal outputted from the Wilkinson type power divider 5 is fed to the RF input terminal 12B of the single channel-reception dual tuner 12. Or, it is preferable that power be supplied to the in-case antenna 102 but not to the rod antenna 101, that the power supply control circuit 10 apply 0 V to the low noise amplifier 3 to turn off the power supply to the low noise amplifier 3 and it apply 3 V to the low noise amplifier 4 to turn on the power supply to the low noise amplifier 4, that the RF switch 7 select the connection point 7B such that an RF signal outputted from the Wilkinson type power divider 6 is fed to the RF input terminal 12A of the single channel-reception dual tuner 12, and that the RF switch 8 select the connection point 8B such that an RF signal outputted from the Wilkinson type power divider 6 is fed to the RF input terminal 12B of the single channel-reception dual tuner 12.

In single channel reception, first operation described below is also performed. In the first operation, only either one of a first reception block formed of the RF and IF circuit 13, the A/D converter 15, and the DFT section 17 and a second reception block formed of the RF and IF circuit 14, the A/D converter 16, and the DFT section 18 is enabled. The single/dual switching section 19 receives a demodulation signal from the enabled one of the reception blocks, and sends it to the deinterleaver 20. The demodulation signal sent to the deinterleaver 20, after being subjected to various interleaving processes by the deinterleaver 20, is decoded by the decoder 22 to be outputted as a transport stream signal from the single channel-reception dual tuner 12. Since only one of the first and second reception blocks is enabled, power consumption can be reduced.

Instead of the first operation described above, second operation described below may be performed. In the second operation, both the first reception block formed of the RF and IF circuit 13, the A/D converter 15, and the DFT section 17 and the second reception block formed of the RF and IF circuit 14, the A/D converter 16, and the DFT section 18 are enabled. The single/dual switching section 19 receives a demodulation signal from the first reception block and a demodulation signal from the second reception block, selectively combines the received demodulation signals for each sub-carrier, and sends a demodulation signal obtained by the selective combination to the deinterleaver 20. The demodulation signal sent to the deinterleaver 20, after being subjected to various interleaving processes by the deinterleaver 20, is decoded by the decoder 22 to be outputted as a transport stream signal from the single channel-reception dual tuner 12. Since the selective combination of the signals is performed for each sub-carrier, the reception carrier signal power to noise power ratio (reception C/N ratio) can be improved.

Instead of the first operation and the second operation described above, third operation may be performed. In the third operation, both the first reception block formed of the RF and IF circuit 13, the A/D converter 15, and the DFT section 17 and the second reception block formed of the RF and IF circuit 14, the A/D converter 16, and the DFT section 18 are enabled. The single/dual switching section 19 receives a demodulation signal from each of the first and second reception blocks, in-phase combines (maximum-ratio combines) the received demodulation signals, and sends a demodulation signal obtained by the in-phase combination to the deinterleaver 20. The demodulation signal sent to the deinterleaver 20, after being subjected to various interleaving processes by the deinterleaver 20, is decoded by the decoder 22 to be outputted as a transport stream signal from the single channel-reception dual tuner 12. In the third operation, the gain of a demodulation signal can be high.

Here, from the viewpoint of resistance against interference waves, in the case, for example, where the RF input terminals of the single channel-reception dual tuner 12 are different from each other in RF reception performance and consideration can be made of the frequency characteristics of the antennas or of mutual coupling with another antenna, another operation may be performed in single channel reception in which, unlike in dual channel reception, power is supplied to both the rod antenna 101 and the in-case antenna 102; the power supply control circuit 10 applies 3 V to the low noise amplifiers 3 and 4 to turn on the power supply to the low noise amplifiers 3 and 4; the RF switch 7 selects the connection point 7A such that an RF signal outputted from the Wilkinson type power divider 5 is fed to the RF input terminal 12A of the single channel-reception dual tuner 12; and the RF switch 8 selects the connection point 8B such that an RF signal outputted from the Wilkinson type power divider 6 is fed to the RF input terminal 12B of the single channel-reception dual tuner 12. Or, still another operation may be performed in which power is supplied to both the rod antenna 101 and the in-case antenna 102; the power supply control circuit 10 applies 3 V to the low noise amplifiers 3 and 4 to turn on the power supply to the low noise amplifiers 3 and 4; the RF switch 7 selects the connection point 7B such that an RF signal outputted from the Wilkinson type power divider 6 is fed to the RF input terminal 12A of the single channel-reception dual tuner 12; the RF switch 8 selects the connection point 8A such that an RF signal outputted from the Wilkinson type power divider 5 is fed to the RF input terminal 12B of the single channel-reception dual tuner 12.

What is claimed is:

1. A dual channel broadcast receiver, comprising:
a first receiving section having:
a first antenna;
a first low noise amplifier for amplifying a signal received by the first antenna; and
a first power divider for dividing a signal fed from the first low noise amplifier into two signals to be outputted therefrom;
a second receiving section having:
a second antenna;
a second low noise amplifier for amplifying a signal received by the second antenna; and
a second power divider for dividing a signal fed from the second low noise amplifier into two signals to be outputted therefrom;
a dual tuner having a first RF input terminal and a second RF input terminal; and
a selecting section for, in dual channel reception, selecting and feeding to the first RF input terminal and the second RF input terminal either a signal fed from the first receiving section or a signal fed from the second receiving section,
wherein
in dual channel reception, when the selecting section selects the signal fed from the first receiving section, power is not supplied to the second antenna, and when the selecting section selects the signal fed from the second receiving section, power is not supplied to the first antenna.

2. The dual channel broadcast receiver of claim 1, wherein
the first power divider and the second power divider are Wilkinson type power dividers.

3. The dual channel broadcast receiver of claim 1, wherein
there is provided a power supply control circuit for individually turning on/off power supply to the first low noise amplifier and power supply to the second low noise amplifier.

4. The dual channel broadcast receiver of claim 1, wherein
the dual tuner is a tuner capable of switching between dual channel reception and single channel reception.

5. The dual channel broadcast receiver of claim 1, wherein
the selecting section has:
a first semiconductor switch for selecting and feeding to the first RF input terminal either the signal fed from the first receiving section or the signal fed from the second receiving section; and
a second semiconductor switch for selecting and feeding to the second RF input terminal either the signal fed from the first receiving section or the signal fed from the second receiving section.

6. The dual channel broadcast receiver of claim 1, wherein
the selecting section has:
a first RF MEMS (radio frequency micro electro mechanical systems) switch for selecting and feeding to the first RF input terminal either the signal fed from the first receiving section or the signal fed from the second receiving section; and
a second RF MEMS switch for selecting and feeding to the second RF input terminal either the signal fed from the first receiving section or the signal fed from the second receiving section.

7. A mobile terminal comprising a dual channel broadcast receiver,
the dual channel broadcast receiver comprising:
a first receiving section having:
a first antenna;
a first low noise amplifier for amplifying a signal received by the first antenna; and
a first power divider for dividing a signal fed from the first low noise amplifier into two signals to be outputted therefrom;
a second receiving section having:
a second antenna;
a second low noise amplifier for amplifying a signal received by the second antenna; and
a second power divider for dividing a signal fed from the second low noise amplifier into two signals to be outputted therefrom;
a dual tuner having a first RF input terminal and a second RF input terminal; and
a selecting section for, in dual channel reception, selecting and feeding to the first RF input terminal and the second RF input terminal either a signal fed from the first receiving section or a signal fed from the second receiving section,
wherein
in dual channel reception, when the selecting section selects the signal fed from the first receiving section, power is not supplied to the second antenna, and when the selecting section selects the signal fed from the second receiving section, power is not supplied to the first antenna.

8. The mobile terminal of claim 7, wherein
the first power divider and the second power divider are Wilkinson type power dividers.

9. The mobile terminal of claim 7, wherein
there is provided a power supply control circuit for individually turning on/off power supply to the first low noise amplifier and power supply to the second low noise amplifier.

10. The mobile terminal of claim 7, wherein
the dual tuner is a tuner capable of switching between dual channel reception and single channel reception.

11. The mobile terminal of claim 7, wherein
the selecting section has:
a first semiconductor switch for selecting and feeding to the first RF input terminal either the signal fed from the first receiving section or the signal fed from the second receiving section; and
a second semiconductor switch for selecting and feeding to the second RF input terminal either the signal fed from the first receiving section or the signal fed from the second receiving section.

12. The mobile terminal of claim 7, wherein
the selecting section has:
a first RF MEMS switch for selecting and feeding to the first RF input terminal either the signal fed from the first receiving section or the signal fed from the second receiving section; and
a second RF MEMS switch for selecting and feeding to the second RF input terminal either the signal fed from the first receiving section or the signal fed from the second receiving section.
